(19) United States
(12) Patent Application Publication
(10) Pub. No.: US 2006/0000365 A1
(43) Pub. Date: Jan. 5, 2006

(54) Cooking vessel

(75) Inventor: Nobile Attie, Kingston, NY (US)

Correspondence Address: DESIGN IP, 5000 W. TILGHMAN STREET, SUITE 153, ALLENTOWN, PA, 18104, US

(73) Assignee: MANA ATTIE LLC, Kingston, NY (US)

(21) Appl. No.: 11/209,910

(22) Filed: Aug. 22, 2005

Related U.S. Application Data
(63) Continuation-in-part of application No. 10/640,101, filed on Aug. 13, 2003, now Pat. No. 6,931,985.
(60) Provisional application No. 60/484,377, filed on Jul. 2, 2003.

(51) Int. Cl. A47J 37/07

(52) U.S. Cl. 99/340; 219/754

(57) ABSTRACT

A cooking vessel that combines the functions of a grill and an oven. The vessel includes a cooking chamber having an upwardly arched ceiling comprised of fire brick. A cooking surface is located within the cooking chamber. A pull-out mechanism is attached to the cooking surface and is adapted to move the cooking surface in and out of the cooking chamber through a front opening. The front opening defines a baffle, which traps heat in the cooking chamber. Two infrared gas burners, located below and outboard from the cooking surface, heat food located on the cooking surface directly. Radiant heat from the ceiling indirectly heats the food.

### BACKGROUND OF THE INVENTION

The present invention relates to a vessel for cooking food.

In commercial cooking, such as in a restaurant, a wide variety of foods must be cooked quickly and efficiently. Ovens and grills are two widely-used types of cooking vessels. Ovens are designed to cook food at relatively low temperatures, through primarily indirect heating (i.e., the food is cooked by heating the entire cooking chamber to the desired temperature). A grill is designed to cook food at higher temperatures. A grill also cooks food using primarily direct heating, typically from a flame or other heat source located directly below the food. If the grill includes an enclosure over the food, some indirect heating also takes place. In order to cook food evenly, conventional grills require food to be turned over during the cooking process.

The present invention combines the functions of both a grill and an oven. In addition, the invention includes many improvements over both grill and oven designs of the prior art.

### BRIEF DESCRIPTION OF THE DRAWINGS

The present invention will hereinafter be described in conjunction with the appended drawing figures wherein like numerals denote like elements.

FIG. 1 is a perspective view of the cooking vessel of the present invention;

FIG. 2 is a sectional view taken along line 2-2 of FIG. 1;

FIG. 3 is a sectional view taken along line 3-3 of FIG. 1;

FIG. 4 is a sectional view taken along line 2-2, showing how heat is distributed throughout the cooking chamber;

FIG. 5 is a sectional view taken along line 2-2, showing a rotisserie installed in the cooking chamber;

FIG. 6 is a front view of a second embodiment of the invention;

FIG. 7 is a partial side view thereof;

FIG. 8 is a sectional view taken alone line 8-8 of FIG. 7;

FIG. 9 is a front view of a third embodiment of the invention; and

FIG. 10 is a sectional view take along line 10-10 of FIG. 9.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms used in the specification and claims to describe portions of the cooking vessel 10 of the present invention (e.g., top bottom, left, right, etc.) reflect the orientation of the cooking vessel 10 in the drawing figures. These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

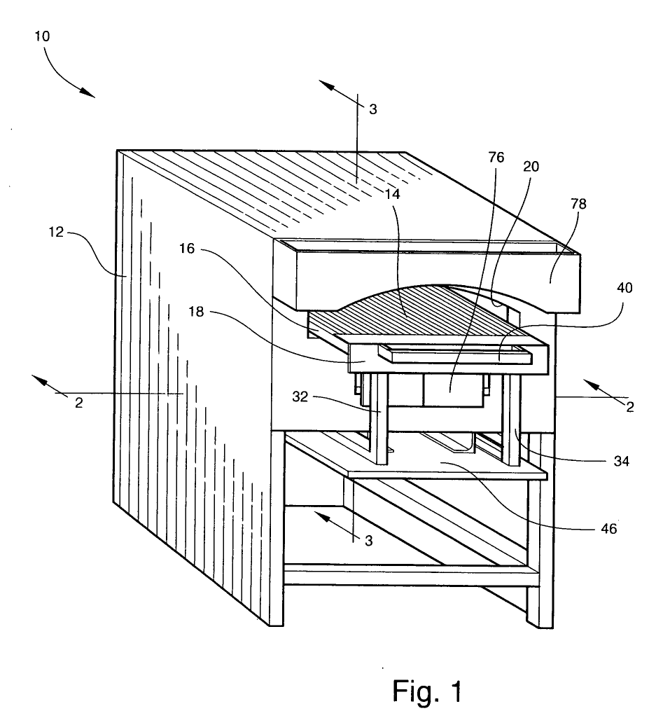

FIG. 1 shows a preferred embodiment of the cooking vessel 10 of the present invention, which includes a cooking surface 16 designed to be contained within a cooking chamber 14. As is conventional with most cooking vessels, an enclosure 12 is preferably provided, which surrounds the cooking chamber 14 and enables the chamber 14 to be located at a convenient height from the floor. Any durable, rigid material is suitable for the enclosure 12, such as 11 gage steel, for example.

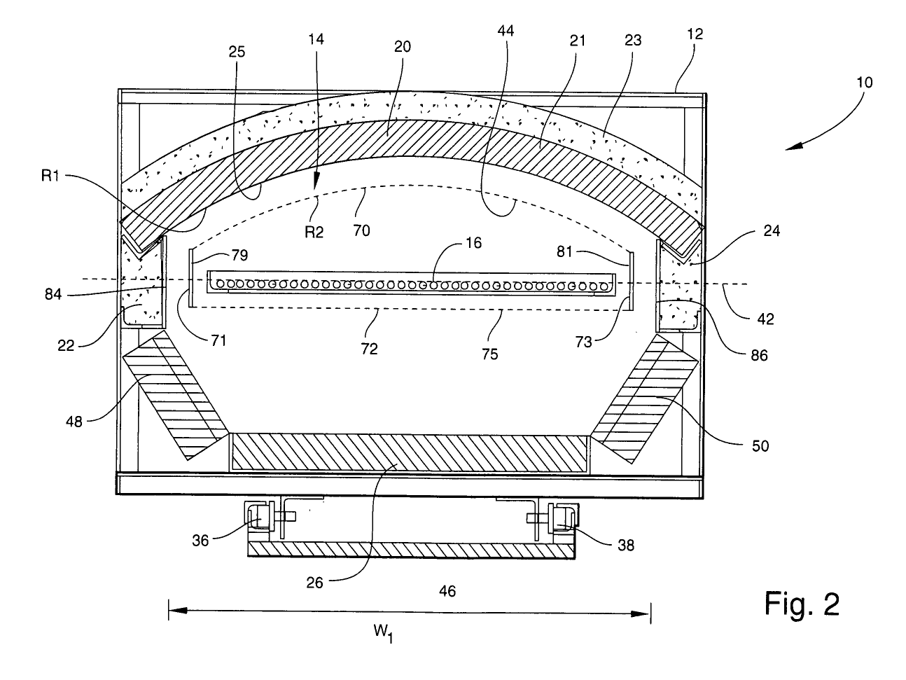

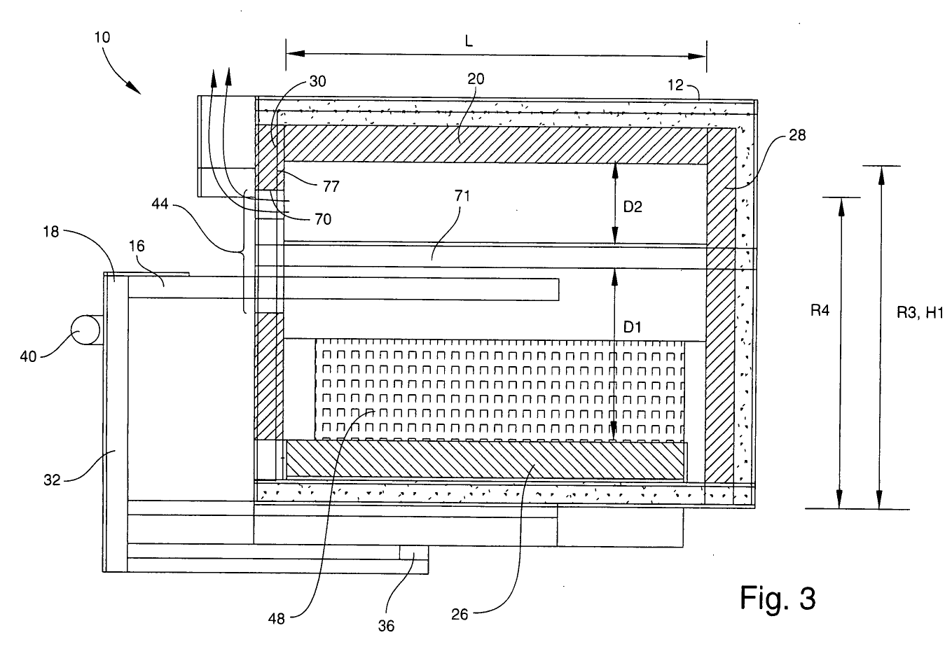

Turning to FIG. 2, the interior of the cooking vessel 10 is shown in greater detail. The cooking chamber 14 is defined by an upwardly arched ceiling 20, a left side wall 22, a right side wall 24, a bottom wall 26, a rear wall 28 and a front wall 30 (see FIG. 3). A front opening 44 is provided in the front wall 30. Two infrared gas burners 48, 50 are located in the lower left and right corners, respectively, of the cooking chamber 14. The cooking surface 16 is preferably centrally located within the cooking chamber 14 and defines a cooking plane 42.

In this embodiment, the cooking surface 16 is shown as a grill (i.e., a surface having members which are spaced apart). The cooking surface 16 is preferably located slightly closer to the ceiling 20 than the bottom wall 26 and within the tense radiant range of the burners 48, 50.

Other types of cooking surfaces are, of course, possible. For example, a hearth (i.e., a sold cooking surface) or a rotisserie could be substituted for the grill. Alternatively, the cooking surface 16 could be a combination of grill and hearth surfaces. A hearth could be accommodated using the same front opening 44 as a grill.

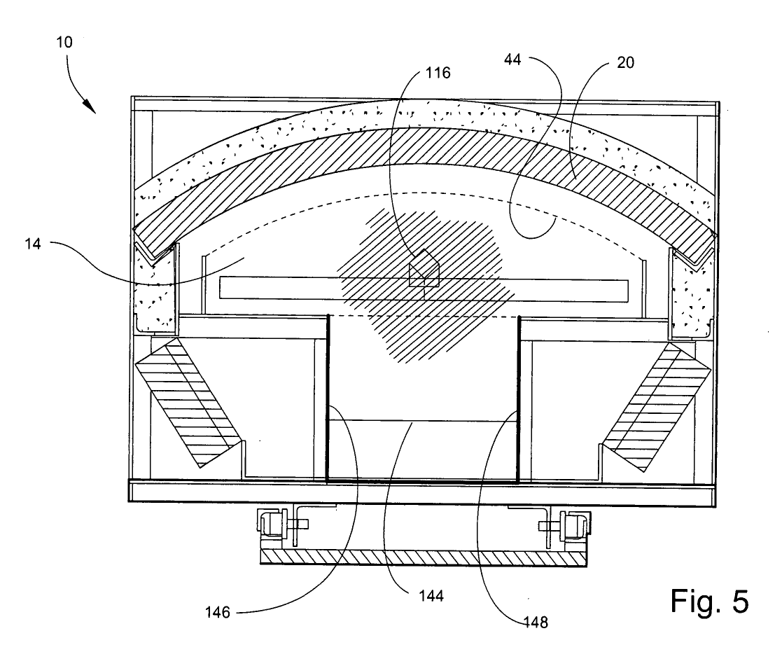

FIG. 5 shows the cooking vessel 10, modified to accommodate a rotisserie 116. A lower portion 144 of the front opening 44 is included, which extends downwardly from the front opening 44 shown in FIG. 2. The location of the left and right sides of the lower portion 144 of the front opening 44 are indicated by reference numerals 146 and 148, respectively. With this modification, service doors 76 (shown in FIG. 1) swing open to enable easy insertion and removal of the rotisserie 116 and close to prevent additional heat loss from the cooking chamber 14 would preferably be provided. The rotisserie 116 could use the same type of pull-out mechanism used with the cooking surface 16, which is described in detail below.

The cooking surface 16 could also include a plurality of removable sections so that it can be replaced with either grill or hearth sections. This allows for maximum flexibility in commercial food establishments (e.g., restaurants), where large quantities of diverse foods must be cooked in a short period of time. Alternatively, the cooking surface 16 could be fixed, rather than slidable or removable.

Referring to FIGS. 1 and 2, the cooking vessel 10 preferably provides for easy insertion and removal of the cooking surface 16 from the cooking chamber 14 through the front opening 44, in order to allow for easy placement and removal of food. In this embodiment, a pull-out mechanism 18 is provided. The pull-out mechanism 18 includes a pair of L-shaped support arms 32, 34 which are each affixed to the cooking surface 16 and a pair of rollers 36, 38, respectively. The rollers 36, 38 allow the lower portions of the support arms 32, 34 to slide horizontally (parallel to the cooking plane 42), which enables the cooking surface 16 to be inserted (closed position) and removed (open position, see FIG. 3) from the cooking chamber 14. The rollers 36, 38 and the lower portions of the support arms 32, 34 are preferably located outside the cooking chamber 16 so that it is not necessary for these components to withstand the intense heat inside the chamber 16. In this embodiment, the rollers 36, 38 are located below the bottom wall 26. Alternatively, the rollers 36, 38 could also be located on the sides of the vessel 10, at or near the vertical position of the cooking surface 16. Other structures, such as ball-bearing slides, for example, could be substituted for the rollers 36, 38. The term “slider,” as used in the specification and claims, is intended to refer to all such structures, including rollers.

A handle 40 is preferably provided to facilitate movement of the pull-out mechanism 18. Optionally, latches or detents (not shown) may be provided to prevent unintended movement of the cooking surface 16. Additional support for the cooking surface 16 (e.g., slides, grooves, guides, etc.) may be included inside the cooking chamber 14 to allow the cooking surface 16 to support larger amounts of food and/or to minimize deflection of the cooking surface 16 when loaded.

The pull-out mechanism 18 also preferably includes a drip pan 46 oriented horizontally and affixed to the lower legs of the support arms. The drip pan 46 is positioned to catch any drippings from the cooking surface 16 when the cooking surface 16 in an open position.

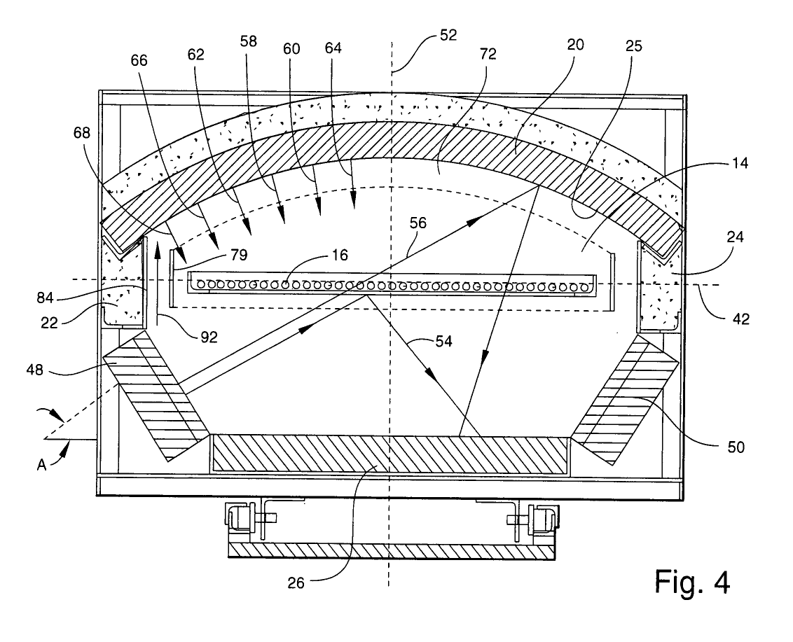

Referring now to FIG. 2, the left and right burners 48, 50 will be described in greater detail. For convenience in describing the relative positions of the burners 48, 50, a vertical axis 52 will be defined (see FIG. 4). The vertical axis 52 bisects the cooking surface 16 from left to right. The left burner 48 is offset to the left of the vertical axis 52 and the right burner 50 is offset to the right of the vertical axis 52. In the interest of brevity, the positioning and orientation of only the left burner 48 will be described in detail. It is understood that the positioning and orientation of the right burner 50 is a mirror image.

Referring now to FIG. 4, the left burner is angled upwardly, so that heat emitted from the burner 48 is directed toward the cooking surface 16. In this embodiment, the angle of incline A is 33 degrees. The cooking vessel 10 will still work reasonably well with moderate variation of the angle of incline A (e.g., 25-40 degrees, and preferably 30-35 degrees). The optimal angle of incline A may be different for other embodiments of the cooking vessel 10 having differently dimensioned cooking chambers 14. In addition, different types of burners may require different angles of incline.

The burner 48 is preferably positioned well to the left of the vertical axis 52. In this embodiment, the burner 48 is positioned almost directly below the left side wall 22, in the lower left corner of the cooking chamber 14.

The burner 48 directly heats of the cooking surface 16 and food (not shown), as well as the ceiling 20. A first heating path for direct heating of the cooking surface 16 is identified by reference numeral 54, which shows heat being directed to the cooking surface 16. As can be seen in FIG. 4, the first heating path 54 intersects the cooking plane 42 at a non-orthogonal angle. Some of the heat from the first heating path 54 will be absorbed by the cooking surface 16 and food and some of the heat is reflected towards the bottom wall 26. A second heating path for direct heating of the ceiling 20 is identified by reference numeral 56. Some of the heat from the second heating path 56 is absorbed by the ceiling 20 and some is reflected toward the bottom wall 26. In order to promote even heating and heat circulation, the second heating path 56 preferably intersects the ceiling to the right of the vertical axis 52.

The relative proportions of heat emitted from the burner 48 that follow the first heating path vs. heat that follows the second heating path depends, in part upon the type of cooking surface used (i.e., a grill having widely-spaced members will allow much more heat to pass through to the ceiling 20 than a hearth), as well as the amount of food placed on the cooking surface 16.

Other types of burners, such as gas burners or electric coil burners, could be substituted for the infrared gas burners 48, 50. Infrared gas burners are preferred because of more even heating characteristics, faster heating and the ability to more efficiently heat surfaces from a distance. If gas burners (either standard or infrared) are used a gas inlet port (not shown) will obviously be required. In addition, the burners 48, 50 are preferably have digital controls (not shown) to provide precise heat control.

The ceiling 20 is preferably formed of a layer of high temperature fire brick 21 positioned inside an insulating layer 23 and includes an inner surface 25 which is preferably arcuate in lateral cross-section (see FIG. 2) and linear in longitudinal cross-section (see FIG. 3). In order to provide sufficient insulation and radiant heating, the insulating layer 23 is preferably at least 1.5 inches thick and the high temperature fire brick 21 is preferably 3-4 inches thick. Any suitable high-temperature insulation can be used, such as 8 pound per cubic foot density ceramic fiber insulation, for example.

The fire brick used in the ceiling 20 is preferably a clayed fire brick comprising at least 50% clay content, 10-15% silica & aluminum content. The remaining content is preferably bonding material.

When the cooking vessel 10 has been pre-heated, the fire brick 21 radiates heat as shown by the lines identified by reference numbers 58, 60, 62, 64, 66, 68. Such radiation heats food on the cooking surface 16 from the top. The upwardly arched shape of the inner surface 25 of the ceiling 20 promotes even heating of food. In this embodiment, the radius of curvature R1 of the inner surface 25 of the ceiling 20 is 30.1 inches. Of course, the cooking vessel 10 will still function reasonably well with minor to moderate variations of the radius of curvature R1 of the inner surface 25 of the ceiling 20 (e.g., 25-35 inches). In addition, the optimal radius of curvature R1 may be different for other embodiments of the cooking vessel 10 having differently dimensioned cooking chambers 14.

The front opening 44 performs two functions: (1) it provides an area for inserting and removing the cooking surface 16 from the cooking chamber 14; and (2) it provides a way for heat to vent from the cooking chamber 14. The venting structure of the present invention eliminates the need for a hood or vertical venting system to be attached to the cooking vessel 10 and allows for higher cooking temperatures and more efficient cooking than a conventional grill having an open top.

The front opening 44 includes a perimeter 72 having an arched top edge 70 and generally linear left and right edges 71, 73 and bottom edge 75. In order to clearly illustrate the shape and location of the perimeter 72 of the front opening 44, it is shown in dashed lines in FIG. 2 even though it does not actually appear in the view shown in FIG. 2.

The arched top edge 70 is preferably has a radius of curvature R2 about two inches smaller than the radius of curvature R1 of the inner surface 25. In addition, the rise R4 of the top edge 70 preferably falls below the rise R3 of the inner surface 25. This difference in radii of curvature and rise creates a baffle 77 that traps heat along the inner surface 25 of the ceiling 20. As with the radii of curvature R1, R2 of the inner surface 25 and the top edge 70, the optimal difference between rises R3, R4 may be different for other embodiments of the cooking vessel 10 having differently dimensioned cooking chambers 14. It has been found that a difference of about two inches is suitable.

A baffle of about two inches is also preferably provided between the left and right side edges 71, 73 of the front opening 44 and the left and right side walls 22, 24, respectively, of the cooking chamber 14. In addition, two inner steel plates 79, 81 (see FIG. 2) are preferably provided. The inner steel plates 79, 81 extend from the left and right edges 71, 73, respectively to the rear of the cooking chamber 14. Corresponding outer steel plates 84, 86, affixed to the left and right side walls 22, 24, respectively, are also preferably provided. The inner steel plates 79, 81 can be removable for cleaning and alternate cooking surface 16 configurations. Any convenient means could be used for such removal, such as slender trays (not shown) upon which each inner steel plate 79, 81 could slide.

As shown in FIG. 4, the left inner steel plate 79 and left outer steel plate 84 channel heat (see line 92) from the left burner 48 upwardly, which prevents cooking temperatures along the outer edges of the cooking surface 16 from being substantially higher than in the center of the cooking surface 16. The right inner plate 81 and right outer plate 86 operate identically to the left inner steel plate 71 and left outer steel plate 84.

A guard 78 is preferably provided on the front of the enclosure 12 above the front opening 44 to channel the vented heat up and away from the operator of the cooking vessel 10.

Location of the left, right and bottom edges 71, 73, 75 of the front opening 44 is less important than that of the top edge 70, so long as the left, right and bottom edges 71, 73, 75 provide sufficient clearance for the cooking surface 16 to be inserted and removed.

The bottom wall 26 preferably includes an absorbent material, such as sand, lava rock, water, etc., to catch drippings from food as it cooks on the cooking surface 16, thereby reducing flare-ups. Use of water as an absorbent material is preferred due to ease of clean-up. If water is used, the bottom wall would preferably include a water-tight tray and a conventional float system to add water during cooking as it evaporates.

The service door 76 preferably also enables access to the portion of the cooking chamber 14 below the cooking surface 16 to clean out food drippings and other debris that falls below the cooking surface 16.

Many other embodiments of the cooking vessel 10 are possible. For example, multiple cooking chambers could be provided. In such an embodiment, an upper cooking chamber could have a fixed hearth (but be otherwise similar in configuration to the single cooking chamber 14) and the lower chamber could include a sliding grill (as in the first embodiment).

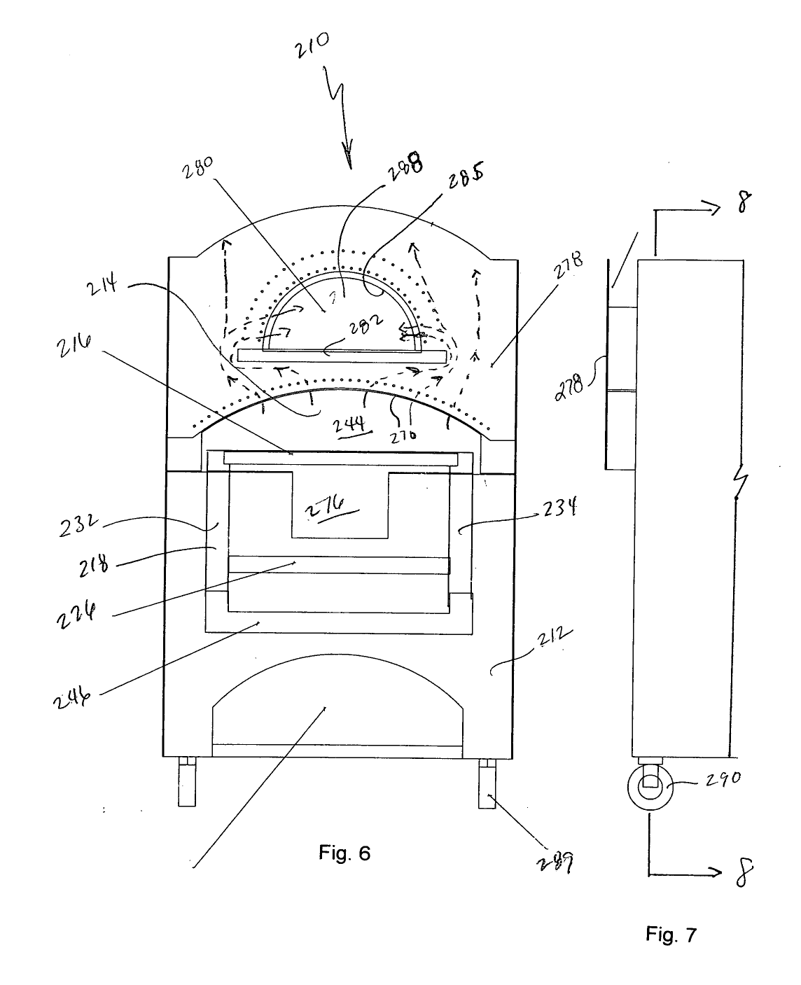

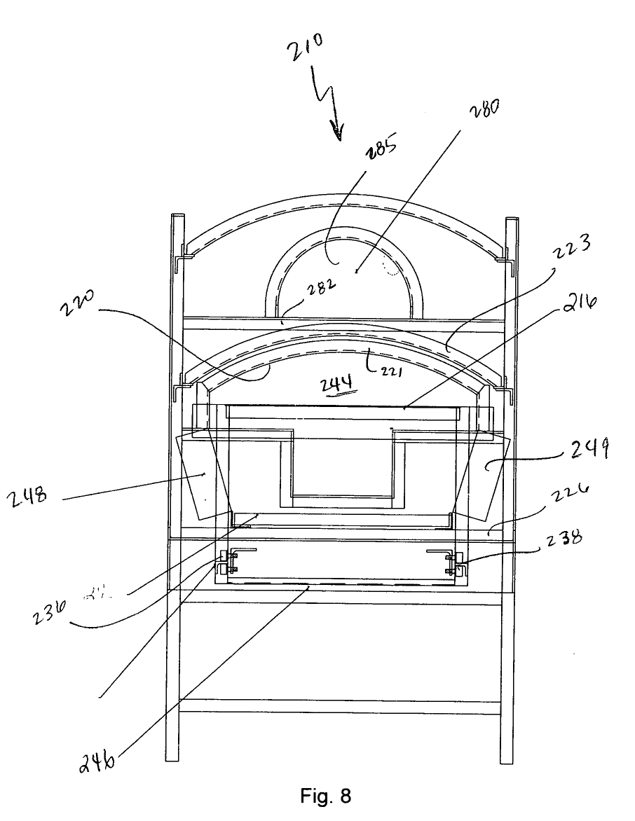

A second embodiment of the invention is shown in FIGS. 6-8. In FIGS. 6-8, features that correspond to features shown in the first embodiment of the cooking vessel 10 are designated by reference numerals that are increased by a factor of 200. For example, the second embodiment of the cooking vessel is designated by reference numeral 210. Features of the second embodiment of the cooking vessel 210 that are described in connection with the first embodiment of the cooking vessel 10 may be labeled in the drawings, but not referred to in the specification. It should be understood that the purpose and configuration of such features is substantially similar to the corresponding features in the first embodiment of the cooking vessel 10.

This embodiment of the cooking vessel 210 includes an oven 280 located above the cooking chamber 214 (for clarity, referred to hereinafter as the “grille cooking chamber”) which contains the cooking surface 216. The oven 280 includes a cooking chamber 285 (for clarity, referred to hereinafter as the “oven cooking chamber”) and front opening 288 that are similar in shape and configuration to the grille cooking chamber 214. The oven 280 preferably includes a fixed hearth 282 formed of fire brick or soap stone, which forms that floor of the oven 280. The hearth 282 includes a lip 283 which extends forwardly to the guard 278, and therefore, forms a portion of the venting structure. The hearth 282 is preferably insulated on its underside to prevent overheating of the hearth 282 from the heat generated by the grille cooking chamber 214.

The oven 280 is preferably operated at a cooler temperature than the grille cooking chamber 314 and in the range of 500-850 degrees Fahrenheit. The grille cooking chamber 314 is designed to operate at temperatures in excess of 850 degrees Fahrenheit. The primary heat source for the oven 280 is located at the rear of the oven cooking chamber 285. A gas-fired pipe burner (see burner 387 of the third embodiment, described below) can be used because it provides a visible flame, which enhances the visual effect of the cooking vessel 210 in open kitchens. Exhaust heat from the grille cooking chamber 214 provides additional heat for the oven cooking chamber 285, which allows the oven cooking chamber to operate more efficiently. Exhaust heat from the grille cooking chamber 214 is shown schematically in FIG. 6 as dashed lines with arrows showing the direction of flow. Exhaust heat that escapes through the opening 244 of the grille cooking chamber 214 is channeled around the lip 283 of the hearth 282 and is kept close to the cooking vessel 210 by the guard 278—creating a hot air “curtain” around the opening 288 of the oven cooking chamber 285. The primary heat source for the oven 280 creates a draft that draws a portion of the exhaust heat from the grille cooking chamber 214 into the oven cooking chamber 285 through the opening 288. This enables the oven to operate more efficiently. The remaining exhaust heat is directed upwardly by the guard 278. In order to channel as much exhaust heat as possible from the grille cooking chamber 214 to the over cooking chamber 285 and to channel exhaust heat from both cooking chambers 214, 285 away from users of the vessel 210, the guard preferably extends from the opening 244 of the grille cooking chamber 214 to the top of the vessel 210.

This embodiment of the cooking vessel 210 may be mounted on casters 289 which allow the vessel 210 to be moved more easily. If provided, the casters 289 are preferably lockable, to prevent unintended movement of the vessel 210 when in use.

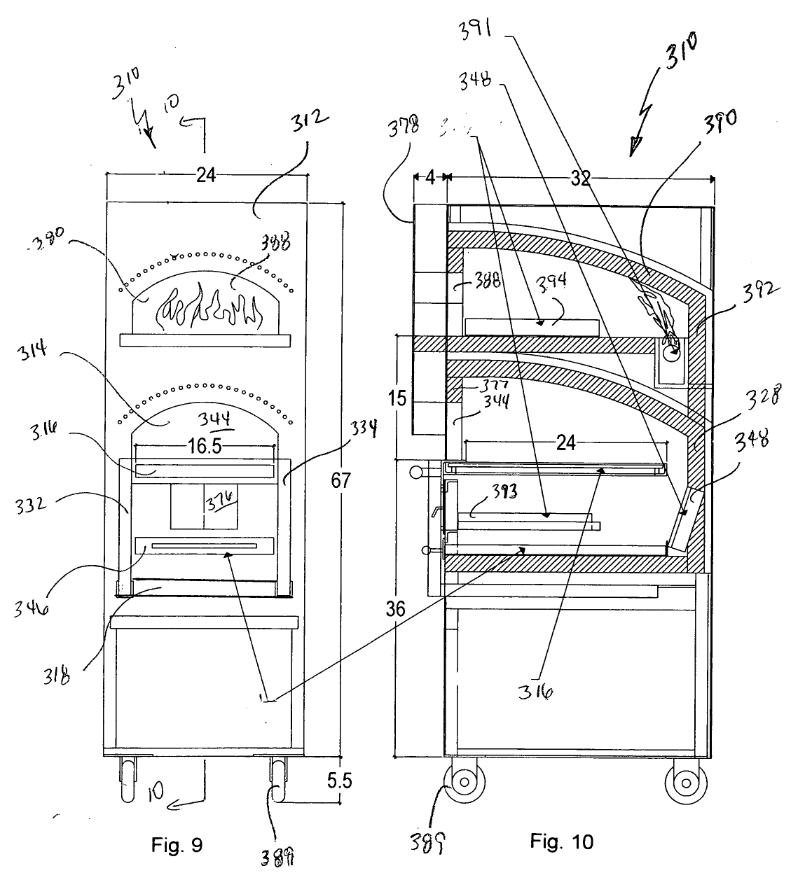

A third embodiment of the invention is shown in FIGS. 9-10. In FIGS. 9-10, features that correspond to features shown in the first embodiment of the cooking vessel 10 and the second embodiment of the cooking vessel 210 are designated by reference numerals that are increased by a factor of 300 and 100, respectively. For example, the second embodiment of the cooking vessel is designated by reference numeral 310 and the oven hearth is designated by reference numeral 387. Features of the third embodiment of the cooking vessel 310 that are described in connection with the first and/or second embodiments of the cooking vessels 10, 210 may be labeled in the drawings, but not referred to in the specification. It should be understood that the purpose and configuration of such features is substantially similar to the corresponding features in the first and/or second embodiments of the cooking vessel 10, 210.

This embodiment of the cooking vessel 310 is similar to the second embodiment of the cooking vessel 210 in that it includes an oven 380 located above the grille cooking chamber 214. In this embodiment, overall size of the cooking vessel 310 is smaller to accommodate smaller kitchens and in applications where multiple units will be used side-by-side. In order to accommodate the smaller overall size, the shape and configuration of the over cooking chamber 285 and the grille cooking chamber 214 are modified. In addition, a stationery drip pan 396 is located on the bottom wall 326 of the grille cooking chamber 314.

In addition to an overall reduction on the width of most components, two significant differences between the first two embodiments and this embodiment are the burner configuration in the grille cooking chamber 314 and the shape of the ceilings 320, 390 of the grille cooking chamber 314 and oven cooking chamber 285, respectively. As can be seen in FIG. 10, the ceilings 320, 390 both arch upwardly from the rear of the cooking chambers 314, 385 (the right-most end in FIG. 10) and reach their highest points at the front of the cooking chambers 314, 385 (the left-most end in FIG. 10). As in the second embodiment, the primary heat source for the oven cooking chamber 385 is located at the rear of the chamber 385. In this embodiment, the primary heat source is a pipe-burner 391 which provides a visually-attractive open flame. In addition, an upwardly-angled single infrared burner 348 is located at the rear of the grille cooking chamber 314, instead of the dual burners located on either side of the grille cooking chamber 14, 214 in the first two embodiments. The configurations of the ceilings 320, 390 and location of the pipe-burner 391 and infrared burner 348, respectively, result in even and efficient heat circulation in the smaller cooking chambers 314, 385 of this embodiment.

As shown in FIG. 10, this embodiment may optionally include wood chip pans 393, 394 in the grille cooking chamber 314 and oven cooking chamber 385, respectively. Smoke from wood chips in the pans 393, 394 enhances the flavor of food being cooked.

In any of the embodiments described herein, the side walls (walls 22,24 in FIGS. 2 & 4) of either or both of the cooking chambers could be make of lava rock instead of fire brick. Lava rock could also be used on the rear walls (see rear wall 28 in FIG. 3 and rear wall 392 in FIG. 10) of the cooking chambers. Lava rock absorbs and radiates less heat than fire brick, and therefore, is a better insulator. Therefore, using lava rock in the side walls reduces the warm-up time of the cooking chamber. In addition, using lava rock on in the rear wall 392 reduces the amount of heat radiated towards the front opening 388, which reduces the amount of heat to which a user of the oven 380 is exposed to when inserting and removing food items from the oven cooking chamber 385.

The embodiments of the invention described herein are likely to be used in a commercial setting, such as a restaurant, for example. However, the invention could also be used beneficially in residential applications.

While the principles of the invention have been described above in connection with preferred embodiments, it is to be clearly understood that this description is made only by way of example and not as a limitation of the scope of the invention.

1. A cooking vessel comprising:
a cooking chamber having an opening;
a heat source;
a cooking surface;
a drip catcher located below the heat source;
a pull-out mechanism that provides support for the cooking surface and enables the heating surface to be inserted and removed from the cooking chamber through the opening;
a mechanical connection that moves that the drip surface with the cooking surface when the cooking surface is removed from the cooking chamber.

2. A cooking vessel comprising:
a cooking chamber defined by an upwardly arched ceiling having an inner surface, a left side wall, a right side wall, a front wall, a rear wall and a bottom wall, the ceiling being located above the left side wall, right side wall and rear wall;
a cooking surface located within the cooking chamber, the cooking surface defining a cooking plane and being bisected from left to right by a first vertical axis;
a pull-out mechanism attached to the cooking surface, the pull-out mechanism being adapted to move the cooking surface in and out of the cooking chamber through the first opening;
a first heat source located below the cooking surface and offset to the left of the first vertical axis, the first heat source being adapted to emit heat along a first direct heating path, the first direct heating path intersecting the cooking plane at a first angle, the first angle being non-orthogonal; and
a second heat source located below the cooking surface and to the right of the first vertical axis, the second heat source being adapted to emit heat along a second direct heating path, the second direct heating path intersecting the cooking plane at a second angle, the second angle being non-orthogonal.
